(19) United States
(12) Patent Application Publication
(10) Pub. No.: US 2023/0053907 A1
(43) Pub. Date: Feb. 23, 2023

(54) METHOD AND APPARATUS FOR FLEXIBLE CONFIGURATION MANAGMENT USING EXTERNAL IDENTITY MANAGEMENT SERVICE

(71) Applicant: ARRIS Enterprises LLC, Suwanee, GA (US)

(72) Inventors: Tat Keung CHAN, San Diego, CA (US); Alexander MEDVINSKY, San Diego, CA (US)

(73) Assignee: ARRIS Enterprises LLC, Suwanee, GA (US)

(21) Appl. No.: 17/891,759

(22) Filed: Aug. 19, 2022

Related U.S. Application Data
(60) Provisional application No. 63/234,953, filed on Aug. 19, 2021.

(51) Int. Cl. H04L 9/40

(52) U.S. Cl. CPC H04L 63/105; H04L 63/20; H04L 63/0884

(57) ABSTRACT

To address the requirements described above, this document discloses a system and method for performing an action on at least one resource node of a hierarchical organization of resource nodes is disclosed. The system utilizes an external Identity Provider that provide more flexible authentication and authorization services, and leverages such services with secure server such as an on-line data signing service to provide flexible permission management.

### BACKGROUND

### 1. Field

The present disclosure relates generally to systems and methods for managing the performance of operations on secure elements, and in particular for a system for managing such performance using an external identity management service.

### 2. Description of the Related Art

It is beneficial in many circumstances to permit regulated access to particular resources via the Internet. Such systems typically verify the identity of those that request access to those resources and manage that access based on the verified identity and pre-defined but configurable rules. One example of such a system is a system used to sign data such as software code.

Data is sometimes provided to devices which have already been distributed to end users (e.g. fielded devices). Such data may be needed to update the device(s) to newer configurations or to perform additional functions, to ameliorate software “bugs” or other issues, or to simply replace data already resident in the device that may have been compromised. Such data may include software instructions (e.g. code) update fielded devices by providing data such as software code to those devices remotely.

One of the problems with the remote downloading of such data to fielded devices is that the data may be from an unauthorized source. An entity providing the data to the fielded devices may pose as a legitimate source of the data, yet provide data that is designed to compromise the security or functionality of the device. For example, the user of the device may be misled into believing that their device needs a software update in order to function properly, and may be provided a bogus uniform resource location (URL) from which to download the software update. If the user downloads and installs the software update from the bogus URL, the code that is actually downloaded may include a virus or other malware that negatively affects the operation of the device, perhaps compromising all of the data (including the user's private information) that was stored by the device before the infected.

To prevent the foregoing problems, code signing techniques can be used to digitally sign data such as executables and scripts. Such signatures confirm the identity of the author of the data and guarantee that the data has not been altered or otherwise corrupted since it was signed. Most code signing paradigms provide a digital signature mechanism to verify the identity of the author of the data or build system, and a checksum to verify that the data object has not been modified. Such code signing paradigms typically use authentication mechanisms such as public key technologies, which rely on data publishers securing their private keys against unauthorized access. The public key used to authenticate the data signature should be traceable back to a trusted root certificate authority (CA) or trusted root public key. If the data signature is traced to a CA or public key that the device user trusts, the user is presumed to be able to trust the legitimacy and authorship of the data that is signed with a key generated by that CA or signing authority.

Systems for data signing are known in the art. Such systems provide a framework that allows different organizations or companies to structure their data signing permission needs as they see fit or to safely permit data signing by other independent organizations. Such data signing systems typically use a fixed hierarchy of entities to manage the signing of data. For example, such a fixed hierarchy may include, in decreasing hierarchical order, a platform entity, a project entity, a model entity and a configuration that defines the signing of the data itself. There are three roles with rigid permission structure: (1) administrators, who can do anything, (2) model managers that can manage users for the configurations subordinate to the model, and (3) users that can use the configuration itself to sign data. Signing systems using this hierarchy are disclosed in U.S. Patent Publication. No.: US 2017/0257380, which is hereby incorporated by reference herein.

In some instances, a more flexible config and permission management is desirable. For example, it may be desirable in the hierarchy of entities to define different or parallel entities, or to assign more or fewer roles to those entities. Alteration of known data signing systems to permit such configurations can be costly and time consuming, and may have application limited to individual clients. What is needed is a system and method permitting more flexible hierarchical entity and role definitions to be used with existing resource access and control management systems to permit actions such as data signing. Such a system and method is described herein.

### SUMMARY

To address the requirements described above, this document discloses a system and method for performing an action on at least one resource node of a hierarchical organization of resource nodes. In one embodiment the method comprises: receiving a login request in secure server; redirecting the login request to an identity provider, the identity provider defining a hierarchical organization of node resources, each node resource having one or more scopes and one or more attributes, each one or more scope associated with a scope permission, wherein each node resource is either a management node resource for maintaining the hierarchical organization of the node resources or a configuration node resource for performing the action; receiving a second login request in the secure server, the second login request comprising client authorization credentials identifying a source of the second login request and permission information describing a permission to perform an action on a node resource, the client authorization credentials provided by the identity provider in response to the redirected login request; receiving a request to perform an action on the node resource; determining if the action is permitted according to the permission information of the client authorization credentials; and if the action is permitted, performing the action on the node resource.

Another embodiment is evidenced by an apparatus having a processor and a communicatively coupled memory storing processor instructions for performing the foregoing operations.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram of an exemplary embodiment of a secure online processing system

FIGS. 2A-2C are diagrams illustrating exemplary operations that can be performed to perform an action on one of the protected resources;

FIG. 3 is a diagram showing a resource node structure that can be used to flexibly define a hierarchical organization of node resources to manage actions performed on those resources;

FIGS. 4A and 4B are diagrams illustrating exemplary embodiments of a hierarchical organization of resource nodes having scopes, users, and attributes; and

FIG. 5 illustrates an exemplary processing system that could be used to implement processing elements of the geolocation system.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

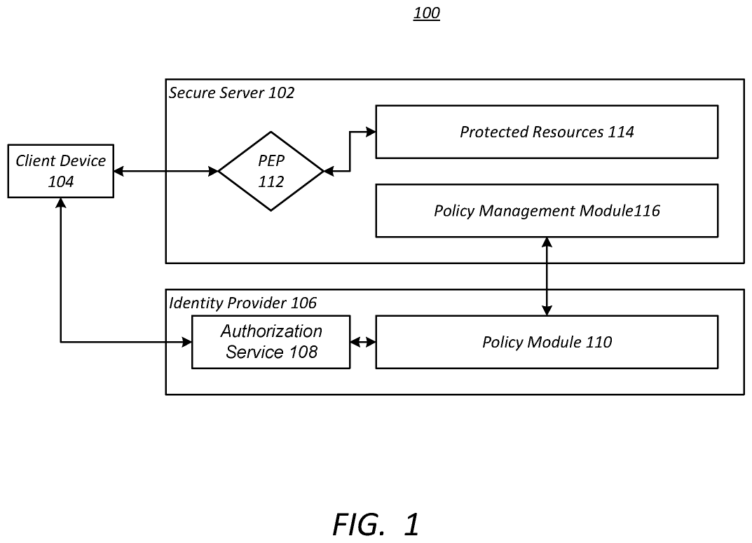

FIG. 1 is a diagram of an exemplary embodiment of a secure online processing system 100. The secure online processing system 100 comprises a secure server 102 communicatively coupled to a client device 104 and an identity provider 106. One example of a third party identity provider is Keycloak. The secure server 102 comprises protected resources 114 such as data signing configurations and management nodes, as described further herein. The secure server 102 also comprises a policy management module 116 that interfaces with the identity provider 106 (for example, via an identity provider application program interface (API) to add, delete, modify, or otherwise manage the policies defined in the identity provider 106, including the names and configuration parameters of resource nodes and their hierarchical structure. The secure server 102 also comprises a policy enforcement point (PEP) 112 that determines if a user/client 104 is authorized for requested operations. As further described below, this is determined from client authorization credentials issued by the identity provider 106 according to the policies defined in the policy module 110 as created and managed by the policy management module 116. These credentials are presented by the client device 104 to the secure server 102.

The identity provider 106 comprises an authorization service module 108 that authenticates communications from the client device 104, and interfaces with the policy module 110 to request client authorization credentials and provide such credentials to the client device 104. In this context, client authorization credentials are essentially an authorization token that specifies permissions for resource nodes for a specific user. This is distinct from the notion of login credentials, such as usernames and passwords, which may also be provided to the identity provider 106.

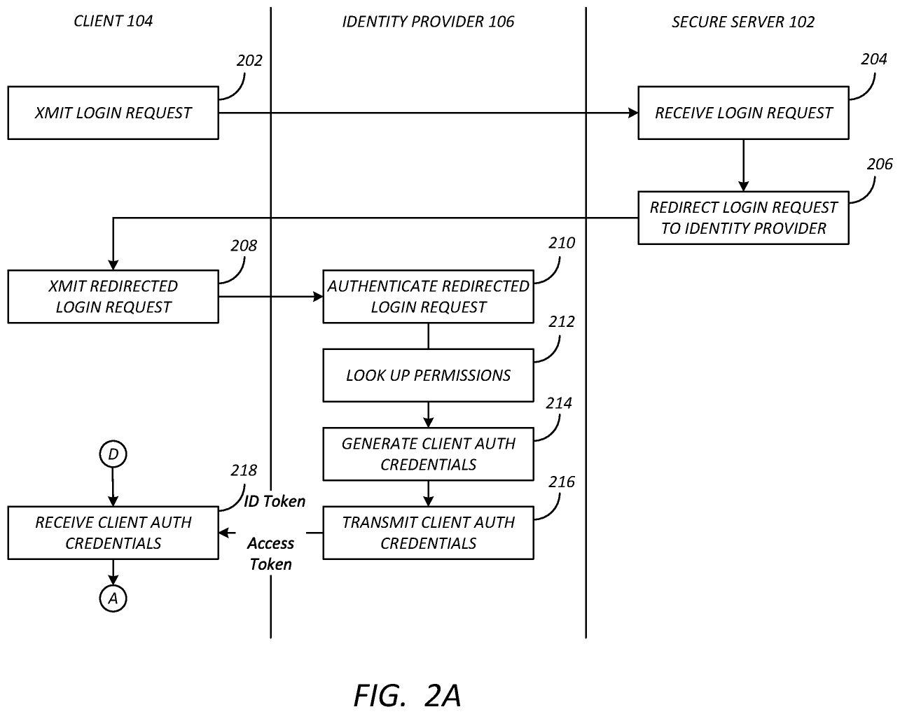

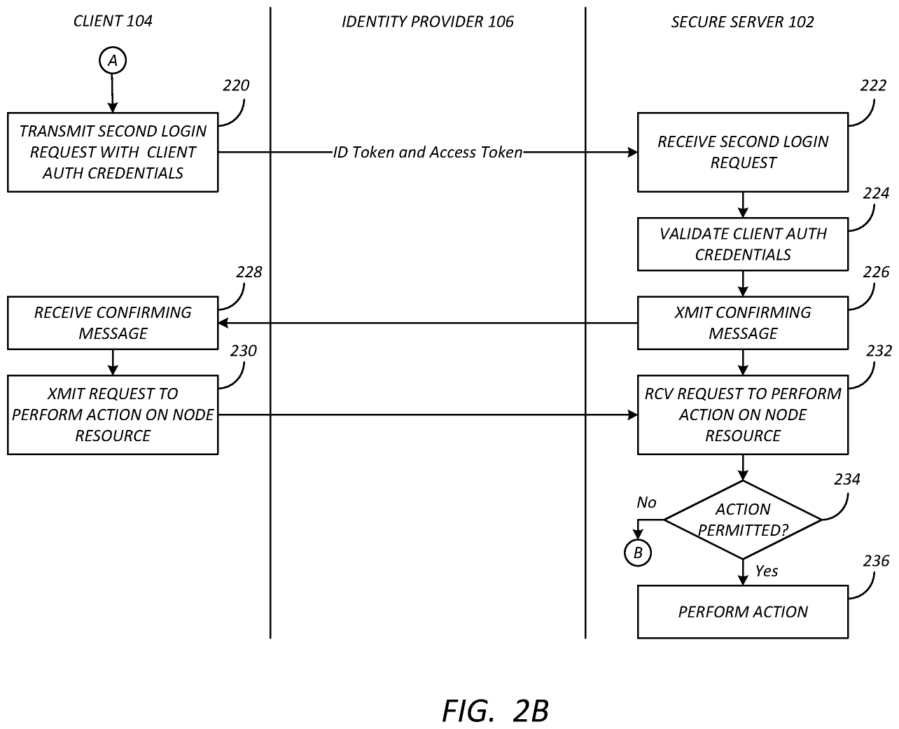

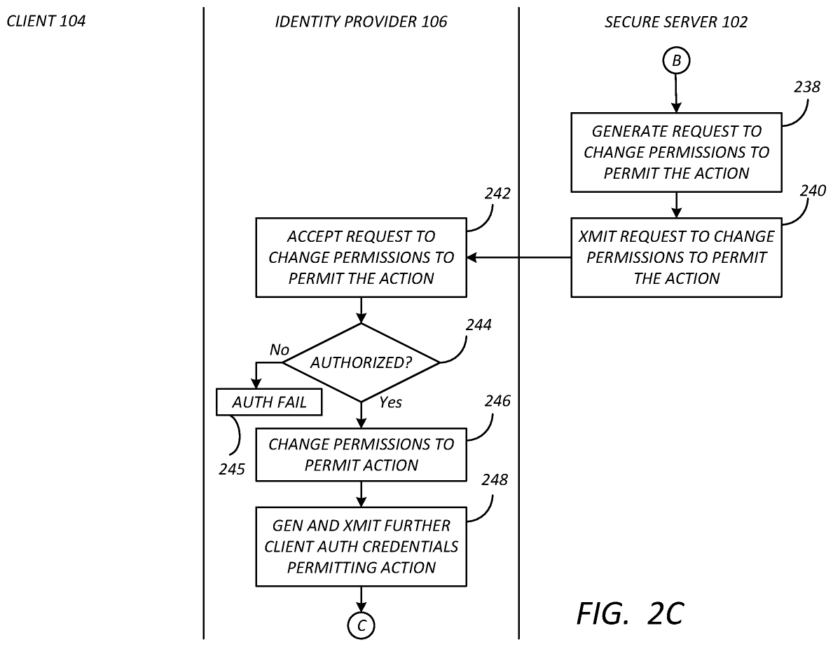

FIGS. 2A-2C are diagrams illustrating exemplary operations that can be performed to perform an action on one of the protected resources 114. In block 202, a login request is transmitted from the client device 104 to the secure server 102. This can be accomplished via a client application installed on the client device 104 such as browser or automated client. The login request typically comprises login credentials such as a login ID and password, but may include other information. In block 204, the secure server 102 receives the login request. At this point, the secure server 102 redirects the login request to the identity provider 106, as shown in block 206. This can be accomplished by transmitting information or command to the client 104 having a link to the identity provider 106 and the client 104 transmitting the redirected login request to the identity provider 106, as shown in block 208, or by simply forwarding the login request to the identity provider 106. The client device 104 logs in to the identity provider 106.

The identity provider 106 implements a hierarchical organization of node resources that is predefined, for example, an administrator of the secure server 102, for example, using an API provided by the identity provider 106 for that purpose. In one embodiment, the policy management module 116 interfaces with the API of the identity provider 106 to define the hierarchical organization and accepts, interprets, and configures such input into a form suitable for the API of the identity provider 106.

In the hierarchical organization of node resources, each node resource has one or more scopes and one or more attributes. Further, each one or more scope is associated with a scope permission, and each node resource is either a management node resource for maintaining the hierarchical organization of the node resources or a configuration node resource for performing the action.

### Resource Node Structure

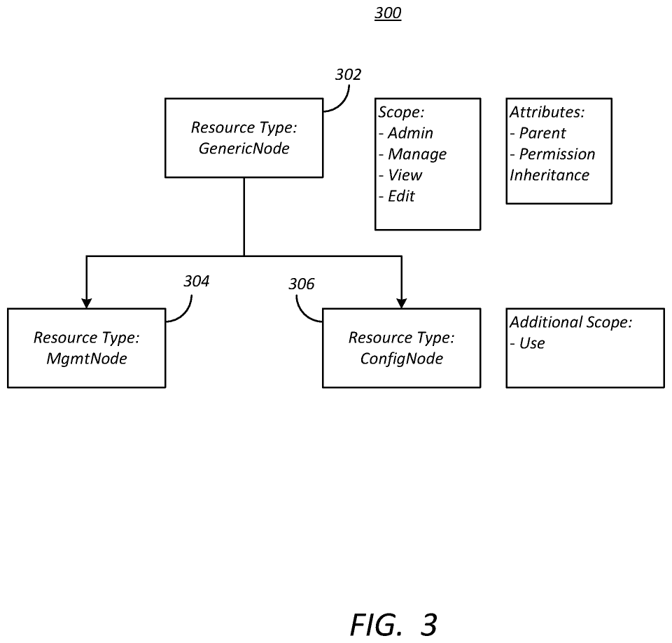

FIG. 3 is a diagram showing a resource node concept 300 that can be used to flexibly define a hierarchical organization of node resources to manage actions performed on those resources. The GenericNode resource type 302 defines a generic node type, which further derives a configuration resource node type 306 (used to perform an action) or a non-configuration resource node type 304 such as a management node (MgmtNode). Each resource is associated with one or more resource scopes that allow fine-grained permission control and one or more resource attributes. The resource scopes for all resource nodes (management nodes and configuration nodes) can include one or more of (1) an administrator (admin) scope, (2) a manage scope, (3) a view scope, and (4) an edit scope. The resource scope for configuration node types 306 may include in addition to the foregoing, a use scope.

Users with the admin scope permission of a resource node can modify any scope permissions for that resource for other users. For example, a user with admin scope permission can assign other administrators, manager, and users to a resource node.

Users with the manage scope permission of a resource node can modify use scope permissions for that resource for other users. For example, a user having a manage scope permission for a resource node can assign users to that resource node (e.g. a configuration node).

Users with the view scope permission of a resource node can view information defined for that resource. For example, if the resource is a configuration node for signing data, such details could include information regarding which signing keys and parameters are used in the signing operations, and a user with a view scope permission can view those details with regard to that configuration node.

Users with the edit scope permission of a resource node can edit the attributes associated with that resource. For example, for a configuration resource that is used to sign data, a user with an edit scope permission can change the data signing parameters.

Users with the use scope permission of a resource node can use any configurations under that resource node, for an example, to perform an action on the resource associated with that resource node. Other scopes may also be defined in addition to those described above.

With regard to attributes, the parent attribute points to the parent resource node (the node immediately superior to the node having the parent attribute). A null parent attribute indicates that the node is superior to all other resource nodes in the hierarchical organization of resource nodes (e.g. it has no parent). The permission inheritance attribute specifies whether permissions associated with that node extend to any child nodes. The permission inheritance can extend to any descendant nodes if all nodes in the chain have permission inheritance attribute turned on.

### Exemplary Hierarchical Organizations of Resource Nodes

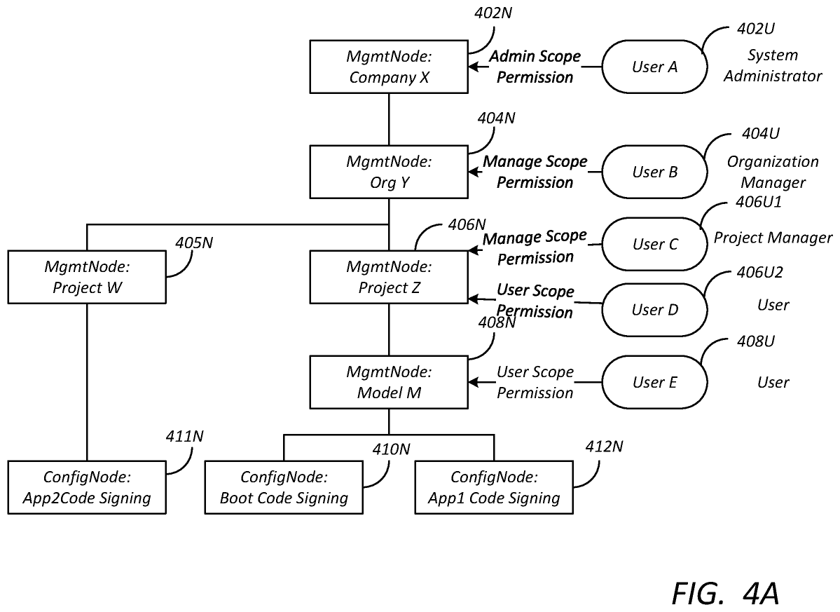

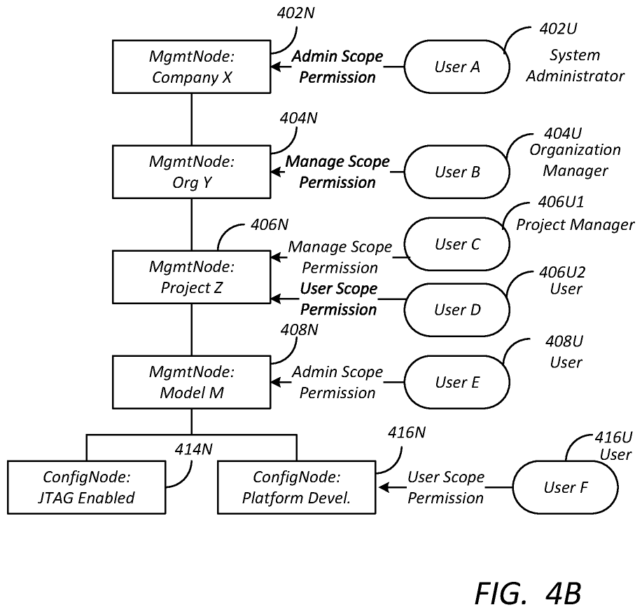

FIGS. 4A and 4B are diagrams illustrating exemplary embodiments of a hierarchical organization of resource nodes having scopes, users, and attributes.

FIG. 4A describes a hierarchical organization of resource nodes that can be used, for example, to sign data. The identity provider's user-based policies are used to manage permissions for each of the resource nodes 402N-412N. Each user 408 is assigned permissions to a specific scope of the resources. The resource nodes include a plurality of management resource nodes 402N-408N, organized in a hierarchy.

The hierarchically topmost node is management resource node 402N for Company X. User A 402U, who is a system administrator, is given admin scope permission of this management node 402N. This means that user A has admin permission and can perform all admin actions on all resource nodes under resource node 402N (e.g. Nodes 404-412N).

Management resource node 404N is a child resource node of management resource node 402N and is hierarchically subordinate to management resource node 402N. This management resource node 404N is associated with an organization (Org Y) within Company X. User B 404U, who is an organization manager, is given manage scope permission of this management resource node 404N, and hence can manage the use permission of the users of all resource nodes under resource node 404N (e.g. resource nodes 406N-412N). In this example, if a use permission for a user is assigned to management resource node 404N, 406N or 408N, that user will have use access to configuration node (ConfigNode) 410N and ConfigNode 412N, as configuration nodes 410N and 412N are hierarchical subordinates (children, grandchildren, or great grandchildren) of management resource nodes 408N, 406N, or 404N, respectively. Also note that management resource node 405N (associated with Project W under Organization Y of Company X) is a child of management resource node 404N, and a parent of configuration node 411N. Hence, user B 404U is given manage scope permission of management resource node 405N and configuration node 411N, and can assign users to configuration node 411N. However, since management resource nodes 406N and 408N are not hierarchically superior to management resource node 405N, users C 406U1, D 406U2, and E 408U are not given manage scope permission of management resource node 405N or configuration node 411N.

Management resource node 406N is a child resource node of management resource node 404N and a grandchild of management resource node 402N and is hierarchically subordinate to both management resource node 402N and management resource node 404N. This management resource node 406N is associated with a project (Project Z) within Org Y and Company X. User C 406U1, who is a project manager, is given manage scope permission of this management resource node 404N, and user D 406U2, who is a user, is given user scope permission of management resource node 406N. This means that user D can use any of the configuration resource nodes under management resource node 406N (e.g. configuration nodes 410N and 412N). User C 406U1 can manage the use permission of users for all resource nodes that are children of management resource node 406N.

Management resource node 408N is a child resource node of management resource node 406N and is hierarchically subordinate to management resource nodes 402N-406N. This management resource node 408N is associated with a model (Model M, for example, a model of a device with boot code) within Project Z of Organization Y in Company X. User E 408U, who is a user, is given user scope permission of this management resource node 408N. This means that user E 408U can use any of the configuration resource nodes under management resource node 408N.

FIG. 4B is a diagram that describes a hierarchical organization of resource nodes that can be used, for example, to access a debug token. A debug token is a signed object of debug permissions tied to a particular device that allows developers to unlock debug features normally turned off during the device's production. When unlocked, such features permit operations and access to memory assets that are normally prohibited. The management of debug token configurations (and the defined configuration resource nodes) is similar to that of the those configuration resource nodes used to sign data as described in FIG. 4A. However, in this example, User E 408U can access any debug configuration resource nodes under management resource node Model M 408N. This includes configuration resource node 414N, which permits access to a JTAG enabling token and configuration resource node 416N which permits a developer to execute an unsigned version of the platform code during development (meaning that when this software token is present in a specific device the bootloader will skip a signature verification check on the platform code). At the same time, user F 416U has use permission access only to the configuration resource node 416N for execution of unsigned platform code, and does not have use permission access to the JTAG enabled token.

JTAG (Joint Test Action Group) is a common hardware interface that is used as the primary means of accessing sub-blocks of integrated circuits, making it an essential mechanism for debugging embedded systems which might not have any other debug-capable communications channel. The JTAG enabling token may include a protected unique secret JTAG key associated with the target device. A single JTAG token can be utilized to unlock JTAG interface of only one specific device.

Users 402U-416U can be human users (accessing the system using a graphical user interface (GUI) or a machine user. Machine users may include a high security machine to machine (M2M) client having a hardware credential such as a universal serial bus (USB) crypto token with login credentials. Alternatively, M2M client may be configured with a software credential such as a software key or digital certificate. One example of a M2M client with a software credential is an application with cloud-based client access via a Representational State Transfer (REST) API. Other user types can also be added.

Returning to FIG. 2A, the identity provider 106 receives and authenticates the redirected login request, as shown in block 210. This can be performed using the same login credentials as described above, or with different or supplementary login credential information. If the redirected login request cannot be authenticated, an error message is returned, but if the request authentication is successful, processing is routed to block 212, which accesses the policy module 110 to look up permissions for the user(s) associated with the redirected login request. Using these permissions, the identity provider 106 or looks up previously generated client authorization credentials that are uniquely associated with those permissions, as shown in block 214. In one embodiment, the client authorization credentials include a identifier (ID) token and a access token. The ID token contains the identity of the user, other user-related information and may include a credentials expiration timestamp. The access token contains all or a subset of permissions to the resources the user is authorized for. The ID token and access token are signed and optionally encrypted by the identity provider 106 for the intended recipient, which is the secure server 102. Once generated, the client authorization credentials are transmitted to the client 104, as shown in block 216.

In block 218, the client device 104 receives the client authorization credentials, as shown in block 218. Now continuing in FIG. 2B, in block 220 the client 104 transmits a second login request to the secure server 102 using the client authorization credentials provided by the identity provider 106. These client authorization credentials indicate the approved permissions of the user of the client device 104 to resource nodes and resource scopes, for example, to perform actions on the resource node(s). In blocks 222 and 224, the secure server 102 receives the second login request and validates the ID token and the access token by verifying the associated signatures and checking that they are not expired. In block 226, the secure server 102 may send a confirming message to the client device 104 indicating that the client authorization credentials are valid. The client device 104 receives the confirming message and transmits a request to perform at least one action on at least one node resource, as shown in blocks 228 and 230. The request can be that of an admin, manage, edit, view, or use scope/function for any management resource node and configuration resource node that the logged in user has the requisite permission. The request is received by the secure server, as shown in block 232. In another embodiment (and in particular, M2M embodiments), the request to perform the action on the resource is transmitted with the second login request, and a confirming message is not required. In such cases, blocks 228-232 are bypassed.

In block 234, the secure server determines if the action is permitted. This is determined according to the permission information of the client authorization credentials provided in block 220. For example, if the client authorization credentials identify a particular user that wants to perform an action associated with a particular resource node, that action is permitted only if the client authorization credentials offered to the secure server 102 (which were generated by the identity provider 106 based on input defining the hierarchical organization of resource nodes, their scopes, and attributes) permit such an action. If the action is permitted, the action on the resource node(s) is performed and any results are provided back to the client 104, as shown in block 236. For example, if the requested action is a data signing operation using a particular configuration represented by a configuration resource node, the indicated signing operation is performed and the signature returned to the client device 104. If the action is not permitted, the secure server 102 may transmit a message to the client device 104 indicating that the action is not permitted. Continuing on FIG. 2C, secure server 102 may alternatively route processing block 238 to generate a request to change the permissions (or the hierarchical organization of resource nodes) as required for the user to be granted permission for the requested action on the resource node. In block 240, the secure server 102 transmits a request to change the permissions to permit the action. In one embodiment, this is accomplished by the policy management module 116 using an API of the identity provider 106 to access the policy module 110 to change the permissions associated with resource nodes or the hierarchical organization of the resource nodes. In block 242, the identity provider 106 accepts the request to change permissions to permit the action, and block 244 determines whether the permission change is authorized. Typically, the administrator of the secure server 102 that defined the hierarchical organization of resource modes and permissions “owns” that hierarchy, and hence, the operations of block 244 involves authenticating that an administrator of the hierarchical organization of resource nodes (e.g. someone with client authorization credentials identifying them as having admin permissions for either the resource node associated with the action or a resource node superior to that resource node in the hierarchy) using secure server 102 made the request. Alternatively, a permission change may be allowed if another admin or management user has updated this user's permissions since the time that the client authorization credentials were issued. In other words, a permissions change may have already been made by another user but it is not reflected in the client authorization credentials which need to be re-issued. If the request to change permissions is not authorized, processing is routed to block 245, which fails the authorization, and a message indicating such failure may be transmitted to the secure server 102 to the user making the request. If the request to change permissions is authorized, block 244 directs processing to block 246, which changes the permissions to permit the requested action. Processing is then routed to block 248 which generates and transmits further client authorization credentials permitting the action to the client 104 device. Processing is then routed to block 218 in FIG. 2A, which receives the further client authorization credentials that permit the initially requested action on the node resource. These credentials are transmitted to the secure server, and the processing of blocks 224-234 in FIG. 2B are performed. Since the user's further client authorization credentials permit the requested action to be performed on the resource, block 234 routes processing to block 236, and the action is performed.

### Permission Management

It is noted that it is possible for an administrator of the identity provider 106 to manage permissions, for example, by logging into the identity provider 106 to manage permissions directly, perhaps at the request of the administrator of the secure server 102 or the user of the client device 104. However, since the administrator of the identity provider 106 can change permissions for all users, more fine grained permission control is not achieved.

Instead, permissions may be managed via the secure server 102. In this instance, a user with administrative privileges logs into the secure server 102 and requests changes to the hierarchical network of resource nodes, for example, changing permissions associated with those nodes, adding, or removing users. The PEP 112 of the secure server 102 checks the ID token and access token to determine if the user's permissions permit the changes, and if so, causes the policy management module 116 to change the hierarchical network of resource nodes, scopes, attributes, and permissions to make the requested changes via the policy module 110 of the identity provider 106. This can be accomplished via an API of the identity provider 106 that is presented for this purpose. This permits finer grained permission control, because the permissions of the administrator of the secure server themselves are limited.

Sample Use Cases

For example, consider a case where a first user tries to grant permission for second user to use a resource node. The first user presents their access token to the secure server 102 which define that first user's permissions. The secure server 102 checks that access token to determine if the first user has permission to “manage scope” of that resource node or any of its superior (ancestor) nodes (e.g. parent nodes, grandparent nodes). If so, the first user's request to update permissions to provide the second user permission to use that resource node is granted using the policy management module 116 and policy module 110 on behalf of the first user. It should be noted that until new client authorization credentials are generated and provided to the second user, the second user will be unable to perform the permitted use of the resource node. Such new or updated client authorization credentials may be pushed to the client device 104 of the second user, or may be provided in response to a request by the client device 104 of the second user to use the node resource.

In another example, a first user attempts to perform an action on a configuration resource node. The first user presents their access token to the secure server 102 which define that first user's permissions. The secure server 102 checks that access token to determine if the first user has permission to use the configuration resource node or any of its superior (ancestor) nodes (e.g. parent nodes, grandparent nodes). If so, the requested action is performed without any interaction with the identity provider 106. If not, the requested action is denied. A user having admin scope permissions may request that the first user be given permission to use that configuration resource node by using the policy management module 116 and policy module 110 to modify the hierarchical organization of resource nodes, scopes, attributes, and permissions, and after the first user receives a new access token permitting the requested use of the configuration resource node, the first user will be able to perform the action.

In yet another example, a first user attempts to add a resource node. The first user presents their access token to the secure server 102 which define that first user's permissions. The secure server 102 checks that access token to determine if the first user has permission to “admin scope” of that resource node or any of its superior (ancestor) nodes (e.g. parent nodes, grandparent nodes). If so, the first user's request to the hierarchical organization of resource nodes to add the resource node and update any required permissions.

### Hardware Environment

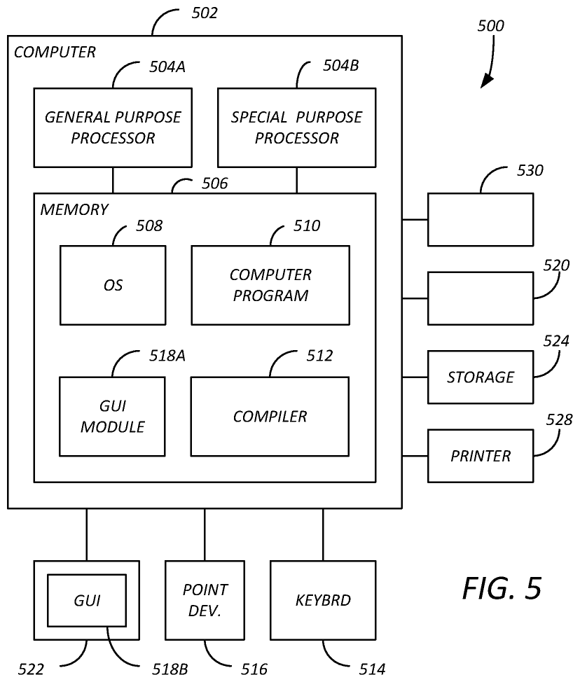

FIG. 5 illustrates an exemplary computer system 500 that could be used to implement processing elements of the above disclosure, including the secure server 102, client device 104, identity provider 106, and any hardware security modules (HSMs) utilized in the system. The computer 502 comprises a processor 504 (which may include a general purpose processor 504A and or a special purpose processor 504B) and a memory, such as random access memory (RAM) 506. The computer 502 is operatively coupled to a display 522, which presents images such as windows to the user on a graphical user interface 518B. The computer 502 may be coupled to other devices, such as a keyboard 514, a mouse device 516, a printer 528, etc. Of course, those skilled in the art will recognize that any combination of the above components, or any number of different components, peripherals, and other devices, may be used with the computer 502.

Generally, the computer 502 operates under control of an operating system 508 stored in the memory 506, and interfaces with the user to accept inputs and commands and to present results through a graphical user interface (GUI) module 518A. Although the GUI module 518B is depicted as a separate module, the instructions performing the GUI functions can be resident or distributed in the operating system 508, the computer program 510, or implemented with special purpose memory and processors. The computer 502 also implements a compiler 512 which allows an application program 510 written in a programming language such as COBOL, C++, FORTRAN, or other language to be translated into processor 504 readable code. After completion, the application 510 accesses and manipulates data stored in the memory 506 of the computer 502 using the relationships and logic that was generated using the compiler 512. The computer 502 also optionally comprises an external communication device such as a modem, satellite link, Ethernet card, or other device for communicating with other computers.

In one embodiment, instructions implementing the operating system 508, the computer program 510, and the compiler 512 are tangibly embodied in a computer-readable medium, e.g., data storage device 520, which could include one or more fixed or removable data storage devices, such as a zip drive, floppy disc drive 524, hard drive, CD-ROM drive, tape drive, etc. Further, the operating system 508 and the computer program 510 are comprised of instructions which, when read and executed by the computer 502, causes the computer 502 to perform the operations herein described. Computer program 510 and/or operating instructions may also be tangibly embodied in memory 506 and/or data communications devices 530, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### Conclusion

This concludes the description of the preferred embodiments of the present disclosure. The foregoing discloses a system and method for performing an action on at least one resource node of a hierarchical organization of resource nodes.

In one embodiment the method comprises: receiving a login request in secure server; redirecting the login request to an identity provider, the identity provider defining a hierarchical organization of node resources, each node resource having one or more scopes and one or more attributes, each one or more scope associated with a scope permission, wherein each node resource is either a management node resource for maintaining the hierarchical organization of the node resources or a configuration node resource for performing the action; receiving a second login request in the secure server, the second login request comprising client authorization credentials identifying a source of the second login request and permission information describing a permission to perform an action on a node resource, the client authorization credentials provided by the identity provider in response to the redirected login request; receiving a request to perform an action on the node resource; determining if the action is permitted according to the permission information of the client authorization credentials; and if the action is permitted, performing the action on the node resource.

Implementations may include one or more of the following features:

Any of the above methods, wherein the one or more scopes of the node resources each include: an admin scope having an admin scope permission permitting a user to modify any scope permission of a node resource associated with the admin scope; a manage scope having a manage scope permission permitting the user to modify a use scope permission of the node resource associated with the manage scope; the one or more scopes of the configuration node resource further include: a use scope having the use scope permission permitting the user to use any configuration of the configuration node resource associated with the use scope.

Any of the above methods, wherein the one or more scopes of the node resources each further include: an edit scope having an edit scope permission permitting the user to edit attributes of the node resource associated with the edit scope; and a view scope having a view scope permission permitting the user to view information defined for node resource associated with the view scope.

Any of the above methods, further including: determining, in the secure server, if the client authorization credentials are valid; and receiving the request in the secure server to perform the action on the resource node only if the client authorization credentials are valid, otherwise denying the request.

Any of the above methods, further including, if the action is not permitted: accepting, from an administrator of the secure server, a request to change the permission of the node resource to permit the action; determining if the requested change of permission is authorized; and if the requested change of permission is authorized, transmitting a request to change the permission of the node resource to the identity provider to permit the action.

Any of the above methods, further including: receiving a third login request in the secure server, the third login request including further client authorization credentials identifying the source of the third login request and updated permission information describing permission to perform the action on the resource node according to the request to change the permission of the node resource.

Any of the above methods, further including: accepting, from an administrator of the secure server, a request to change the permission of the node resource; determining if the requested change of permission is authorized; and if the requested change of permission is authorized, transmitting a request to change the permission of the node resource to the identity provider.

Any of the above methods, further including: receiving a third login request in the secure server, the third login request including further client authorization credentials identifying the source of the third login request and updated permission information describing permission to perform a second action on the resource node according to the request to change the permission of the node resource.

Any of the above methods, wherein the one or more attributes include: a parent attribute specifying a parent node; and a permission inheritance attribute specifying whether a scope permission of the node resource extends to subordinate node resources.

Any of the above methods, wherein the client authorization credentials include: an identifier (id) token identifying the source of the second login request; and an access token having permission information, the permission information describing permission to perform an action on the node resource.

Any of the above methods, wherein the secure server is a data signing server and the action is signing the data.

Another embodiment is evidenced by a system for performing an action on at least one resource node of a hierarchical organization of resource nodes, including: a processor; a memory, communicatively coupled to the processor, the memory storing processor instructions including processor instructions for: receiving a login request in secure server; redirecting the login request to an identity provider, the identity provider defining a hierarchical organization of node resources, each node resource having one or more scopes and one or more attributes, each one or more scope associated with a scope permission, wherein each node resource is either a management node resource for maintaining the hierarchical organization of the node resources or a configuration node resource for performing the action; receiving a second login request in the secure server, the second login request including: client authorization credentials identifying a source of the second login request and permission information describing a permission to perform an action on a node resource, the client authorization credentials provided by the identity provider in response to the redirected login request. The processor instructions also includes processor instructions for receiving a request to perform an action on the node resource, for determining if the action is permitted according to the permission information of the client authorization credentials, and if the action is permitted, performing the action on the node resource.

Implementations may include one or more of the following features:

Any system described above, wherein: the one or more scopes of the node resources each include: an admin scope having an admin scope permission permitting a user to modify any scope permission of a node resource associated with the admin scope; a manage scope having a manage scope permission permitting the user to modify a use scope permission of the node resource associated with the manage scope; and the one or more scopes of the configuration node resource further include: a use scope having the use scope permission permitting the user to use any configuration of the configuration node resource associated with the use scope.

Any system described above, wherein the one or more scopes of the node resources each further include: an edit scope having an edit scope permission permitting the user to edit attributes of the node resource associated with the edit scope; and a view scope having a view scope permission permitting the user to view information defined for node resource associated with the view scope.

Any system described above, wherein the processor instructions further include processor instructions for: determining, in the secure server, if the client authorization credentials are valid; and receiving the request in the secure server to perform the action on the resource node only if the client authorization credentials are valid, otherwise denying the request.

Any system described above, wherein the processor instructions further include processor instructions for: accepting, from an administrator of the secure server, a request to change the permission of the node resource to permit the action; determining if the requested change of permission is authorized; and if the requested change of permission is authorized, transmitting a request to change the permission of the node resource to the identity provider to permit the action.

Any system described above, wherein the processor instructions further include: receiving a third login request in the secure server, the third login request including further client authorization credentials identifying the source of the third login request and updated permission information describing permission to perform the action on the resource node according to the request to change the permission of the node resource.

Any system described above, wherein the one or more attributes include: a parent attribute specifying a parent node; and a permission inheritance attribute specifying whether a scope permission of the node resource extends to subordinate node resources.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of performing an action on at least one resource node of a hierarchical organization of resource nodes, comprising:
receiving a login request in secure server;
redirecting the login request to an identity provider, the identity provider defining a hierarchical organization of node resources, each node resource having one or more scopes and one or more attributes, each one or more scope associated with a scope permission, wherein each node resource is either a management node resource for maintaining the hierarchical organization of the node resources or a configuration node resource for performing the action;
receiving a second login request in the secure server, the second login request comprising:
client authorization credentials identifying a source of the second login request and permission information describing a permission to perform an action on a node resource, the client authorization credentials provided by the identity provider in response to the redirected login request;
receiving a request to perform an action on the node resource;
determining if the action is permitted according to the permission information of the client authorization credentials; and
if the action is permitted, performing the action on the node resource.

2. The method of claim 1, wherein:
the one or more scopes of the node resources each comprise:
an admin scope having an admin scope permission permitting a user to modify any scope permission of a node resource associated with the admin scope;
a manage scope having a manage scope permission permitting the user to modify a use scope permission of the node resource associated with the manage scope;
the one or more scopes of the configuration node resource further comprise:
a use scope having the use scope permission permitting the user to use any configuration of the configuration node resource associated with the use scope.

3. The method of claim 2, wherein the one or more scopes of the node resources each further comprise:
an edit scope having an edit scope permission permitting the user to edit attributes of the node resource associated with the edit scope; and
a view scope having a view scope permission permitting the user to view information defined for node resource associated with the view scope.

4. The method of claim 3, further comprising:
determining, in the secure server, if the client authorization credentials are valid; and
receiving the request in the secure server to perform the action on the resource node only if the client authorization credentials are valid, otherwise denying the request.

5. The method of claim 3, further comprising, if the action is not permitted:
accepting, from an administrator of the secure server, a request to change the permission of the node resource to permit the action;
determining if the requested change of permission is authorized; and
if the requested change of permission is authorized, transmitting a request to change the permission of the node resource to the identity provider to permit the action.

6. The method of claim 5, further comprising:
receiving a third login request in the secure server, the third login request comprising further client authorization credentials identifying the source of the third login request and updated permission information describing permission to perform the action on the resource node according to the request to change the permission of the node resource.

7. The method of claim 3, further comprising:
accepting, from an administrator of the secure server, a request to change the permission of the node resource;
determining if the requested change of permission is authorized; and
if the requested change of permission is authorized, transmitting a request to change the permission of the node resource to the identity provider.

8. The method of claim 7, further comprising:
receiving a third login request in the secure server, the third login request comprising further client authorization credentials identifying the source of the third login request and updated permission information describing permission to perform a second action on the resource node according to the request to change the permission of the node resource.

9. The method of claim 3, wherein:
the one or more attributes comprise:
a parent attribute specifying a parent node; and
a permission inheritance attribute specifying whether a scope permission of the node resource extends to subordinate node resources.

10. The method of claim 9, wherein a null parent attribute indicates a hierarchically topmost node.

11. The method of claim 1, wherein:
the client authorization credentials comprise:
an identifier (ID) token identifying the source of the second login request; and
an access token having permission information, the permission information describing permission to perform an action on the node resource.

12. The method of claim 1, wherein the secure server is a data signing server and the action is signing the data.

13. A system for performing an action on at least one resource node of a hierarchical organization of resource nodes, comprising:
a processor;
a memory, communicatively coupled to the processor, the memory storing processor instructions including processor instructions for:
receiving a login request in secure server;
redirecting the login request to an identity provider, the identity provider defining a hierarchical organization of node resources, each node resource having one or more scopes and one or more attributes, each one or more scope associated with a scope permission, wherein each node resource is either a management node resource for maintaining the hierarchical organization of the node resources or a configuration node resource for performing the action;
receiving a second login request in the secure server, the second login request comprising:
client authorization credentials identifying a source of the second login request and permission information describing a permission to perform an action on a node resource, the client authorization credentials provided by the identity provider in response to the redirected login request;
receiving a request to perform an action on the node resource;
determining if the action is permitted according to the permission information of the client authorization credentials; and
if the action is permitted, performing the action on the node resource.

14. The system of claim 13, wherein:
the one or more scopes of the node resources each comprise:
an admin scope having an admin scope permission permitting a user to modify any scope permission of a node resource associated with the admin scope;
a manage scope having a manage scope permission permitting the user to modify a use scope permission of the node resource associated with the manage scope; and
the one or more scopes of the configuration node resource further comprise:
a use scope having the use scope permission permitting the user to use any configuration of the configuration node resource associated with the use scope.

15. The system of claim 14, wherein the one or more scopes of the node resources each further comprise:
an edit scope having an edit scope permission permitting the user to edit attributes of the node resource associated with the edit scope; and
a view scope having a view scope permission permitting the user to view information defined for node resource associated with the view scope.

16. The system of claim 15, wherein the processor instructions further comprise processor instructions for:
determining, in the secure server, if the client authorization credentials are valid; and
receiving the request in the secure server to perform the action on the resource node only if the client authorization credentials are valid, otherwise denying the request.

17. The system of claim 15, wherein the processor instructions further comprise processor instructions for:
accepting, from an administrator of the secure server, a request to change the permission of the node resource to permit the action;
determining if the requested change of permission is authorized; and
if the requested change of permission is authorized, transmitting a request to change the permission of the node resource to the identity provider to permit the action.

18. The system of claim 17, wherein the processor instructions further comprise:
receiving a third login request in the secure server, the third login request comprising further client authorization credentials identifying the source of the third login request and updated permission information describing permission to perform the action on the resource node according to the request to change the permission of the node resource.

19. The system of claim 15, wherein:
the one or more attributes comprise:
a parent attribute specifying a parent node; and
a permission inheritance attribute specifying whether a scope permission of the node resource extends to subordinate node resources.

20. A system for performing an action on at least one resource node of a hierarchical organization of resource nodes, comprising:
means for receiving a login request in secure server;
means for redirecting the login request to an identity provider, the identity provider defining a hierarchical organization of node resources, each node resource having one or more scopes and one or more attributes, each one or more scope associated with a scope permission, wherein each node resource is either a management node resource for maintaining the hierarchical organization of the node resources or a configuration node resource for performing the action;
means for receiving a second login request in the secure server, the second login request comprising:
client authorization credentials identifying a source of the second login request and permission information describing a permission to perform an action on a node resource, the client authorization credentials provided by the identity provider in response to the redirected login request;
means for receiving a request to perform an action on the node resource;
means for determining if the action is permitted according to the permission information of the client authorization credentials; and
means for performing the action on the node resource if the action is permitted.
